(19) United States
(12) Patent Application Publication
(10) Pub. No.: US 2013/0040257 A1
(43) Pub. Date: Feb. 14, 2013

(54) Method and Plant For Manufacturing Cement

(71) Applicant: Thoger Kobke Christiansen, Majadajonda (ES)

(72) Inventor: Thoger Kobke Christiansen, Majadajonda (ES)

(73) Assignee: FLSMIDTH A/S, Valby (DK)

(21) Appl. No.: 13/500,110

(22) PCT Filed: Oct. 6, 2010
(86) PCT No.: PCT/IB2010/054523

§ 371 Date: Jun. 25, 2012

(30) Foreign Application Priority Data
Oct. 7, 2009 (DK) PA 200901099

(51) Int. Cl. C04B 7/44; C04B 7/52; F27B 7/20; B02C 4/00; B02C 23/18

(52) U.S. Cl. 432/103; 241/27; 241/18

(57) ABSTRACT

A method for manufacturing cement by which method cement raw materials, such as limestone and clay, are comminuted in a comminution apparatus for subsequently being heated and burned into cement clinker. The cement clinker is then cooled and directed to a comminution apparatus for comminution to cement. For some embodiments of the method, the cement raw materials and cement clinker may undergo comminution in one and the same comminution apparatus.

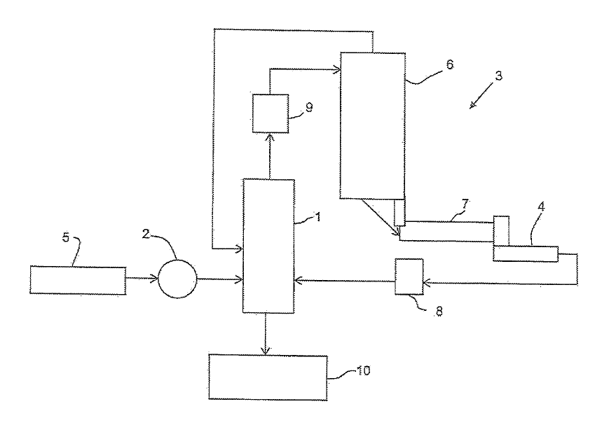

### CROSS REFERENCE TO RELATED APPLICATIONS

This application is the United States national stage under 35 U.S.C. §371 of International Application No. PCT/IB2010/054523, filed on Oct. 6, 2010, which claimed priority to Danish Patent Application No. PA 2009 01099, filed on Oct. 7, 2009. The entirety of these applications is incorporated by reference herein.

### FIELD OF THE INVENTION

The invention relates to a method for manufacturing cement by which method cement raw materials, such as limestone and clay, are comminuted in a comminution apparatus for subsequently being heated and burned into cement clinker which is subsequently cooled and then directed to a comminution apparatus for comminution to cement. The invention also relates to a plant for carrying out the method.

### BACKGROUND OF THE INVENTION

A method as well as a plant for manufacturing cement is well-known in the cement manufacturing industry. In fact, the method described is used in most cement plants around the world. Two separate comminution apparatuses for cement raw materials and cement clinker, respectively, are used in order to perform simultaneous processing of both types of material.

For many years, the machines and processes for producing cement have been continuously improved or been replaced by new technologies. At the same time the typical capacity of the modern cement plant has also increased. For a project involving the installation of a cement plant having a capacity deemed to be small by today's standards, only two basic solutions have been available up until now. One solution is to scale down a large modern cement plant maintaining nearly the same process and number of machines but of a smaller size. However, this solution has a number of disadvantages, for example the fact that the costs for engineering, civil design and supervision of erection to a high degree are independent of the size of the installation. A further disadvantage is that many of the modern machines would have to be redesigned to smaller capacities resulting in costly scaling-down problems. As a consequence hereof, the investment cost per unit of production capacity for a small modern installation will be considerably higher than the cost of a larger installation. Another solution would be to design the plant using the technology available at the point in time where a plant of the requested size was still considered to be normal. Also this solution has significant disadvantages. One problem is that the design does not take advantage of the significant technical advances made in recent years resulting in plants which compared to today's standards are more polluting, less energy-efficient, have lower run factors, and requiring more manpower to operate. Furthermore, the use of old design will result in higher cost of civil works and erection and, moreover, the quality of the produced cement might not live up to modern standards.

### SUMMARY OF THE INVENTION

It is the objective of the present invention to provide a method for obtaining a small modern cement plant with an investment and operation cost per tonne of finished cement which is equivalent to that of larger size plants, while at the same time complying with modern standards in terms of energy efficiency, emission levels and product quality.

This is obtained according to the invention by a method of the kind mentioned in the introduction and being characterized in that the cement raw materials and the cement clinker are alternately comminuted in one and the same comminution apparatus.

In instances where only one comminution apparatus for comminution of both cement raw materials and cement clinker is installed in a cement plant the cost for the plant will be reduced significantly. In particular, it is feasible to use an existing modern comminution apparatus in a small cement plant, even though the capacity of the comminution apparatus exceeds the need for a small cement plant if used only for processing cement raw materials or cement clinker. Thus it will not be necessary to carry out costly down-scaling of existing comminution apparatus or to use outdated comminution apparatus with small capacities for a small cement plant. Moreover, the use of a modern comminution apparatus will ensure low emission levels and the required product quality.

The comminution apparatus may be a roller press, a ring roller mill or similar equipment as long as the comminution apparatus is capable of performing separate and alternate comminution of cement raw materials and cement clinker to the required quality. However, it is preferred that the comminution apparatus is a vertical roller mill since such a mill offers a number of advantages compared to other types of comminution apparatuses. A vertical roller mill is very energy-efficient and has a high degree of flexibility which will enable it to comminute a wide range of materials with different characteristics. Furthermore, it will be fairly uncomplicated to modify most of the parameters for the vertical roller mill, such as table speed and comminution pressure, of importance for the quality of the comminuted material. Moreover, it will be possible to empty a vertical roller mill of material in a very short time, which is a factor of great importance since the apparatus will be alternately used for comminution of cement raw materials and cement clinker or visa versa.

It is preferred that the comminution apparatus is capable of changing between comminution of cement raw materials and cement clinker within one hour and preferably within one minute. The change between materials may occur once or twice a day or at a higher frequency. It is furthermore preferred that the comminution apparatus is not stopped during the changeover. In this way the comminution apparatus will be able to empty itself of cement raw materials when the supply of cement raw materials is stopped and afterwards is ready to accept cement clinker or vice versa.

If the comminution apparatus is a vertical roller mill, parameters such as the pressure on the rollers, the table speed and the air flow through the mill may be adjusted during the changeover. This might be necessary in order to obtain the required quality of both cement raw materials and finish cement as the cement raw materials and the cement clinker have different material characteristics entailing potential need for differentiated processing.

In a large modern cement plant cement raw materials will typically be excavated only from the quarry and crushed in a main crusher during day shifts. As the comminution apparatus for processing the materials in such a plant normally operates 20-22 hours per day, an intermediate storage must be installed in order to provide the comminution apparatus with the necessary cement raw materials. The intermediate storage consists of piles of material which are normally stacked and reclaimed automatically. The piles typically contain the cement raw materials needed for 2-6 days of operation. From the piles the cement raw materials are extracted and transported to feed bins and subsequently fed to the comminution apparatus. Given that the comminution apparatus in the present invention will only be processing cement raw materials during a part of the day, it is feasible that the comminution apparatus and the main crusher will operate solely during the same period of time, preferably from the morning until the afternoon where the quarry is active. As a result, it will not be necessary to have a storage between the comminution apparatus and the main crusher for compensating for a difference during the period of operation. This will lower the cost of the cement plant.

Other details, objects, and advantages of the invention will become apparent as the following description of certain present preferred embodiments thereof and certain present preferred methods of practicing the same proceeds.

### BRIEF DESCRIPTION OF THE DRAWINGS

The invention will now be explained in further detail with reference to the drawing, being diagrammatical, and where the Figure shows a plant according to the invention.

### DETAILED DESCRIPTION OF PRESENT PREFERRED EMBODIMENTS

The Figure shows a plant for manufacturing cement where cement raw materials are excavated from a quarry 5 and directed to a main crusher 2 which performs preliminary crushing. From the main crusher 2 the cement raw materials are directed to a vertical roller mill 1 for comminution to a size which is suitable for the production of cement clinker. Afterwards the comminuted cement raw materials are led into a heating and burning installation 3, comprising a preheater 6 and a rotary kiln 7, for being burned into cement clinker. The hot cement clinker is directed to a clinker cooler 4 where it is cooled before being directed to a silo 8. From the silo 8 the cement clinker is directed to the vertical roller mill 1 for comminution to cement. The vertical roller mill 1 is capable of performing alternate comminution of cement raw materials and cement clinker. The supply of the two types of material is controlled in such a way that only one type of material at the time is supplied to the vertical roller mill 1. The supply of the other material is put on hold until a changeover is needed. When cement raw materials are comminuted the finished cement raw materials are directed to the preheater 6 via a silo 9. Because the heating and burning installation 3 is operating also while cement clinker is being comminuted it is necessary to install the silo 9 for the cement raw materials between the vertical roller mill 1 and the preheater 6 in order to be able to feed the heating and burning installation 3 when the vertical roller mill 1 is comminuting cement clinker. When the vertical roller mill 1 is comminuting cement clinker the finished cement is directed to a storage 10.

The vertical roller mill 1 is capable of changing between comminution of cement raw materials and cement clinker within a short period of time, preferably within one minute. When a changeover is needed the supply of one of the materials is stopped without stopping the vertical roller mill 1. Hence the vertical roller mill 1 will empty itself whereafter the supply of the other material can be activated. During the changeover parameters such as the pressure on the rollers, the table speed and the air flow through the vertical roller mill 1 may be adjusted. This might be necessary in order to obtain the required quality of both cement raw materials and finished cement. The changeover of the parameters may be effected simply by activating a switch placed in the control board for the vertical roller mill 1.

While certain present preferred embodiments of the plant for manufacturing cement and certain embodiments of methods of practicing the same have been shown and described, it is to be distinctly understood that the invention is not limited thereto but may be otherwise variously embodied and practiced within the scope of the following claims.

1. A method for manufacturing cement by which method cement raw materials are comminuted in a comminution apparatus for subsequently being heated and burned into cement clinker which is subsequently cooled and then directed to a comminution apparatus for comminution to cement, the method comprising:
alternatively comminuting in one and the same comminution apparatus the cement raw materials and the cement clinker.

2. The method of claim 1 wherein the comminution apparatus changes between comminution of cement raw materials and cement clinker within one hour or within one minute.

3. The method of claim 1 wherein the comminution apparatus is operating when changing from comminuting the cement clinker to comminuting the cement raw materials.

4. The method of claim 1 wherein the comminution apparatus and a main crusher solely operate within a same period of time.

5. The method of claim 1 wherein the comminution apparatus is a vertical roller mill.

6. The method of claim 5 wherein air flow and roller pressure in the vertical roller mill are adjusted when alternating from between the comminution of cement raw materials and cement clinker.

7. The method of claim 1 wherein the comminution apparatus is a roller press.

8. A plant for manufacturing cement comprising:
a comminution apparatus for comminuting cement raw materials;
a heating and burning installation for producing cement clinker, the cement raw materials comminuted by the comminution apparatus being fed to the heating and burning installation for producing the cement clinker; and
a clinker cooler for receiving the cement clinker and cooling the cement clinker; and
wherein the comminution apparatus also receives the cooled cement clinker and is also for comminuting the cement clinker, the comminution apparatus performing separate and alternate comminution of said cement raw materials and said cement clinker.

9. The plant of claim 8 wherein the comminution apparatus is a roller press, a ring roller mill, a roller mill or a vertical roller mill.

10. The plant of claim 8 wherein comminution pressure of the comminution apparatus is adjusted when alternating from between the comminution of cement raw materials and cement clinker.

11. The plant of claim 8 wherein the comminution apparatus between comminution of cement raw materials and cement clinker within one hour or within one minute.

12. The plant of claim 8 wherein the cement raw materials are comprised of at least one of limestone and clay.

13. The plant of claim 8 further comprising a first silo between the comminution apparatus and the burning installation, the silo receiving comminuted cement raw materials prior to the comminuted cement raw materials being transported to the heating and burning installation.

14. The plant of claim 13 further comprising a storage, the storage receiving the comminuted cement clinker from the comminution apparatus.

15. The plant of claim 14 further comprising a second silo, the second silo positioned between the comminution apparatus and the clinker cooler to receive the cooled cement clinker from the clinker cooler prior to the cooled cement clinker being fed to the comminution apparatus for comminution of the cement clinker.

16. The plant of claim 8 wherein the heating and burning installation is comprised of a preheater and a kiln, the comminuted cement raw materials being fed to the preheater to be heated prior to being sent to the kiln to be burned into cement clinker

17. The method of claim 1 wherein the comminution apparatus is operating when changing from comminuting the cement raw materials to comminuting the cement clinker.
